(19) United States
(12) Patent Application Publication
(10) Pub. No.: US 2011/0088626 A1
(43) Pub. Date: Apr. 21, 2011

(54) ADJUSTABLE ANIMAL FEEDER

(76) Inventors: Kenneth R. Hepp, Oconomowoc, WI (US); Keith W. McCord, Florissant, MO (US); Dennis P. Tronca, Grafton, WI (US); Roger V. Hajny, Cedarburg, WI (US); Thomas J. Green, West Bend, WI (US)

(21) Appl. No.: 12/833,722

(22) Filed: Jul. 9, 2010

Related U.S. Application Data
(63) Continuation-in-part of application No. 12/791,313, filed on Jun. 1, 2010.
Application No. 12/791,313 is a continuation-in-part of application No. 11/588,760, filed on Oct. 27, 2006, now Pat. No. 7,726,259.
(60) Provisional application No. 61/224,359, filed on Jul. 9, 2009.
(60) Provisional application No. 60/731,318, filed on Oct. 28, 2005.
(60) Provisional application No. 60/800,794, filed on May 16, 2006.

(51) Int. Cl. A01K 5/00

(52) U.S. Cl. 119/52.4

(57) ABSTRACT

An animal feeder is mountable to an exterior support and includes an inner housing having a cavity for containing feed and an outer housing for selectively blocking and providing access to the cavity. Access is dependent upon a force exerted on the outer housing. The animal feeder also includes an adjustment mechanism for adjusting the force required to block access.

### RELATED APPLICATIONS

The present application is a continuation-in-part of co-pending U.S. patent application Ser. No. 12/791,313 filed Jun. 1, 2010, which is a continuation-in-part of U.S. application Ser. No. 11/588,760, filed Oct. 27, 2006, and claims the benefit of U.S. Provisional Application Ser. No. 60/731,318, filed Oct. 28, 2005 and U.S. Provisional Application Ser. No. 60/800,794, filed May 16, 2006. The present application also claims priority under 35 U.S.C. §119 to Provisional Patent Application Ser. No. 61/224,359 filed Jul. 9, 2009. The disclosures of all of which are hereby incorporated by reference.

### BACKGROUND

The present invention relates to an animal feeder with selective feed access. Feeders dispense feed to animals and may be operable to allow animals having a first size to access the feed and to prevent animals having a second size from accessing the feed, the second size being greater than the first size.

### SUMMARY

In one construction, the invention provides an animal feeder mountable to an exterior support. The animal feeder includes an inner housing having a cavity for containing feed, an outer housing for selectively blocking and providing access to the cavity, wherein access is dependent upon a force exerted on the outer housing. The animal feeder also includes an adjustment mechanism for adjusting the force required to block access.

In another construction, the invention provides an animal feeder mountable on an exterior support. The animal feeder includes an inner housing defining a cavity for containing feed and including at least one port for providing access to the cavity and an outer housing having at least one opening and being supported on the inner housing for movement relative to the housing between an opened position and a closed position. In the opened position, the at least one opening and the at least one port are substantially aligned, and in the closed position, the at least one opening and the at least one port are substantially misaligned. The outer housing is in the opened position in response to a first force on the outer housing, and the outer housing is in the closed position in response to a second force on the outer housing. The second force is greater than the first force. The animal feeder also includes a guard mechanism coupled between the inner housing and the outer housing for facilitating movement between the opened position and the closed position, the guard mechanism including an adjustment mechanism for adjusting the sensitivity of the guard mechanism such that the value of the second force required to place the outer housing in the closed position is adjustable.

In another construction, the invention provides an animal feeder mountable on an exterior support. The animal feeder includes an inner housing defining a cavity for containing feed and including at least one port for providing access to the cavity, an outer housing having at least one opening and being supported on the inner housing for movement relative to the housing between an opened position, in which the at least one opening and the at least one port are substantially aligned, and a closed position, in which the at least one opening and the at least one port are substantially misaligned, a spring coupled between the inner housing and the outer housing for applying a spring force between the inner housing and the outer housing, and an adjustment mechanism for adjusting the spring force.

Other aspects of the invention will become apparent by consideration of the detailed description and accompanying drawings.

### BRIEF DESCRIPTION OF THE DRAWINGS

FIG. 1 illustrates a perspective view of an animal feeder according to an embodiment of the invention.

FIG. 2 illustrates bottom view of a portion of the animal feeder of FIG. 1.

FIG. 3 illustrates a cross-section of the animal feeder of FIG. 1 taken at A-A of FIG. 2.

FIG. 4 illustrates a side view of the animal feeder of FIG. 1.

FIG. 5 illustrates an exploded perspective view of the animal feeder of FIG. 1.

FIG. 6A illustrates a cross-section of the animal feeder of FIG. 1 taken at A-A of FIG. 2 with the feeder in an open state.

FIG. 6A illustrates a cross-section of the animal feeder of FIG. 1 taken at A-A of FIG. 2 with the feeder in a closed state.

FIG. 7 illustrates multiple views of an outer housing of the animal feeder of FIG. 1.

FIG. 8 illustrates an exploded perspective view of the outer housing of FIG. 7.

FIG. 9 illustrates multiple views of an inner housing of the animal feeder of FIG. 1.

FIG. 10 illustrates an exploded perspective view of the inner housing of FIG. 9.

FIG. 11 illustrates multiple views of a lower spring mount of the inner housing of FIG. 9.

FIG. 12 illustrates more views of the lower spring mount of the inner housing of FIG. 9.

FIG. 13 illustrates another view of the lower spring mount of the inner housing of FIG. 9.

FIG. 14 illustrates still another view of the lower spring mount of the inner housing of FIG. 9.

FIG. 15 illustrates multiple views of an upper spring mount of the outer housing of FIG. 7.

FIG. 16 illustrates another view of the upper spring mount of the outer housing of FIG. 7.

FIG. 17 illustrates multiple views of a portion of the outer housing of FIG. 7.

FIG. 18 illustrates another view of the portion of the outer housing of FIG. 17.

FIG. 19 illustrates a perch portion of the outer housing of FIG. 7.

FIG. 20 illustrates a spring element of the animal feeder of FIG. 1.

FIG. 21 illustrates multiple views of a locking element of the animal feeder of FIG. 1.

FIG. 22 illustrates multiple views of a straw element of the animal feeder of FIG. 1.

FIG. 23 illustrates various elements of the outer housing of FIG. 7.

FIG. 24 illustrates multiple views of a spring adjuster mounting member of the animal feeder of FIG. 1.

FIG. 25 illustrates multiple views of a spring adjuster key of the animal feeder of FIG. 1.

FIG. 26 illustrates multiple views of a feed bin of the inner housing of FIG. 9.

FIG. 27 illustrates another view of the feed bin of FIG. 26.

FIG. 28 illustrates multiple view of a feed port of the inner housing of FIG. 9.

FIG. 29 illustrates additional views of the feed port of FIG. 28.

FIG. 30 illustrates further additional views of the feed port of FIG. 28.

FIG. 31 illustrates multiple views of a feed diverter of the inner housing of FIG. 9.

FIG. 32 illustrates another view of the feed diverter of FIG. 31.

FIG. 33 illustrates additional views of the feed diverter of FIG. 31.

### DETAILED DESCRIPTION

Before the various embodiments of the present invention are explained in detail, it is to be understood that the invention is not limited in its application to the details of construction and the arrangements of components set forth in the following description or illustrated in the drawings. The invention is capable of other embodiments and of being practiced or of being carried out in various ways. It is to be understood that phraseology and terminology used herein with reference to device or element orientation (such as, for example, terms like “top,” “side”, “upper,” “lower,” “front,” and the like) are only used to simplify description of the present invention, and do not alone indicate or imply that the device or element referred to must have a particular orientation. The elements of the feeder and hanger referred to in the present invention can be installed and operated in any orientation desired. In addition, terms such as “first,” “second,” and “third” are used herein for purposes of description and are not intended to indicate or imply relative importance or significance.

Also, the use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

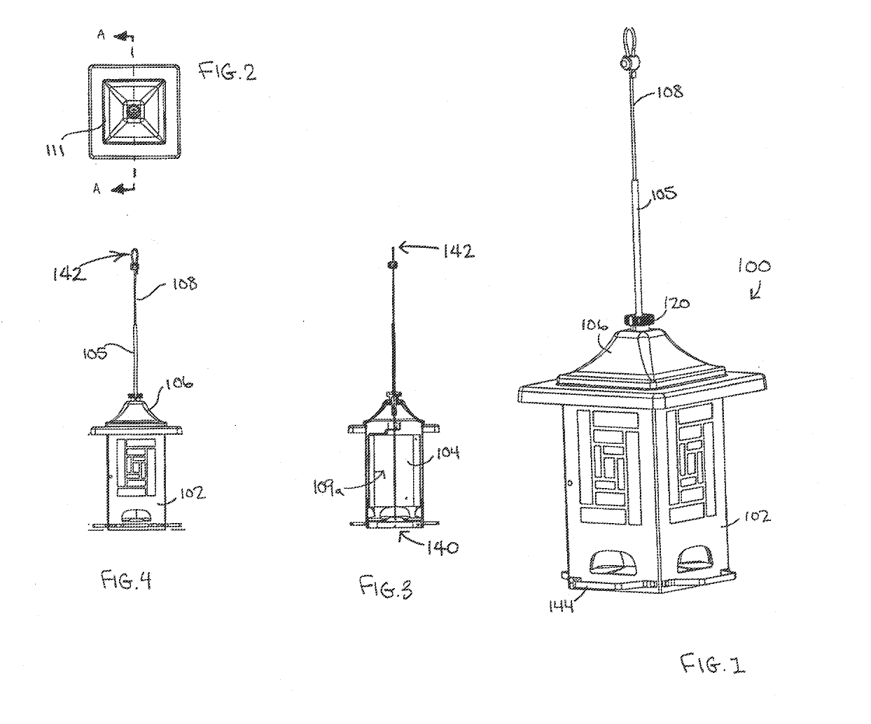

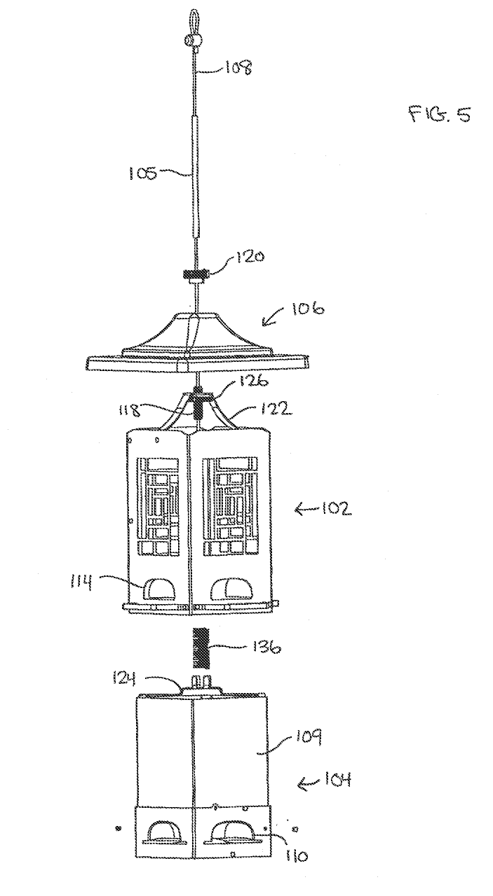

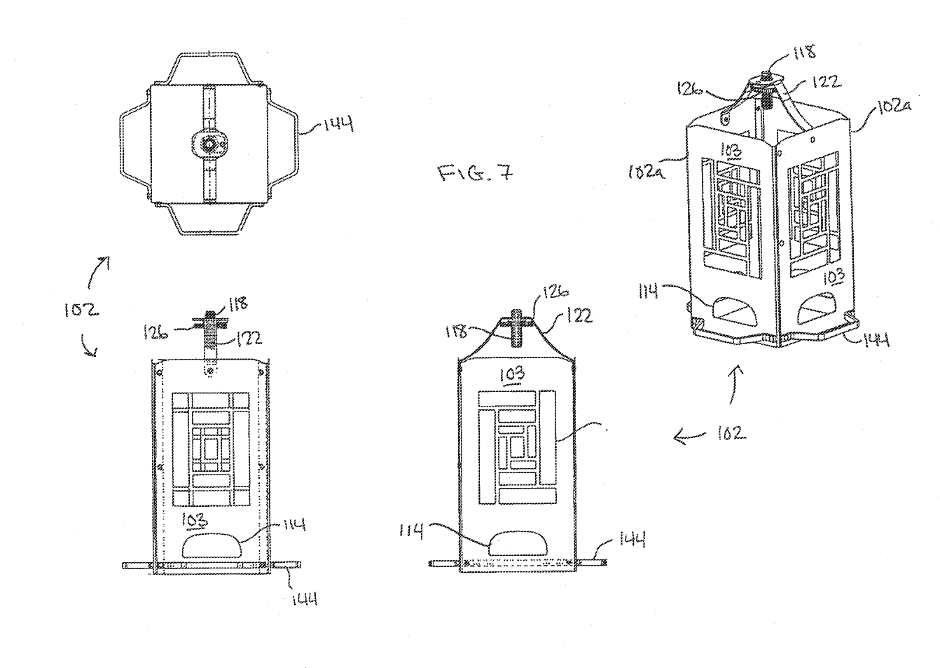

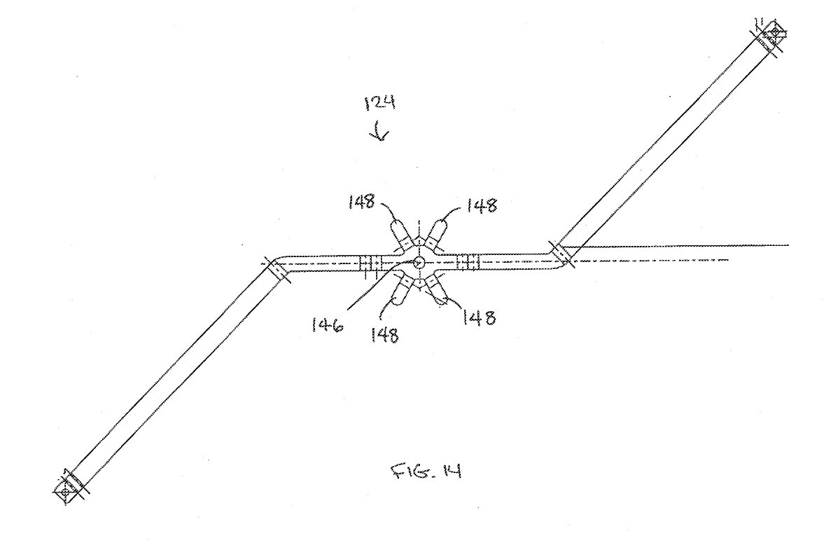

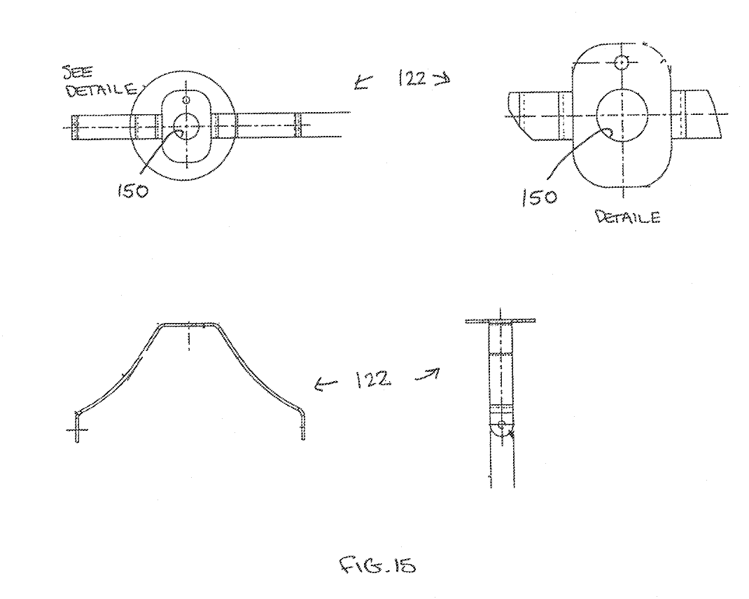

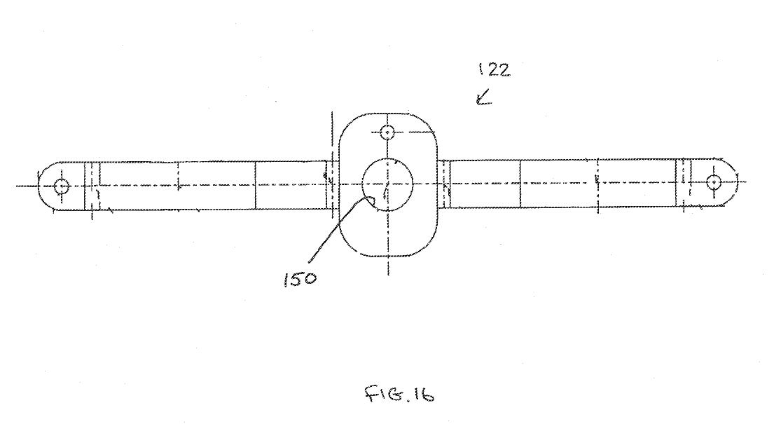

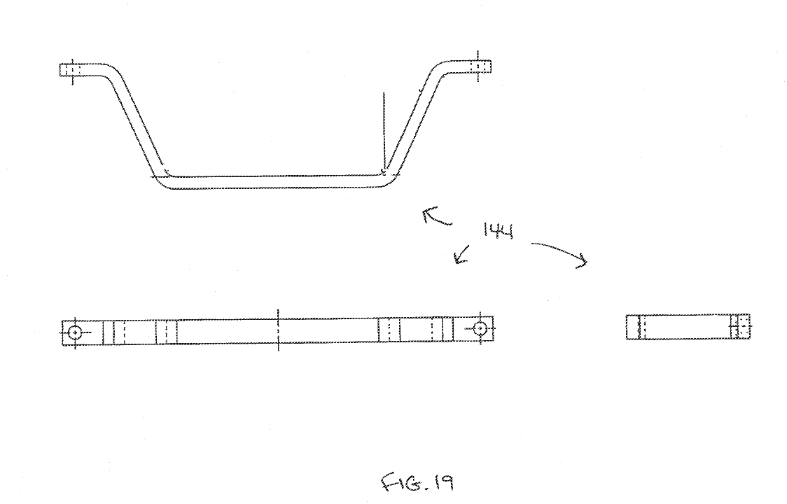

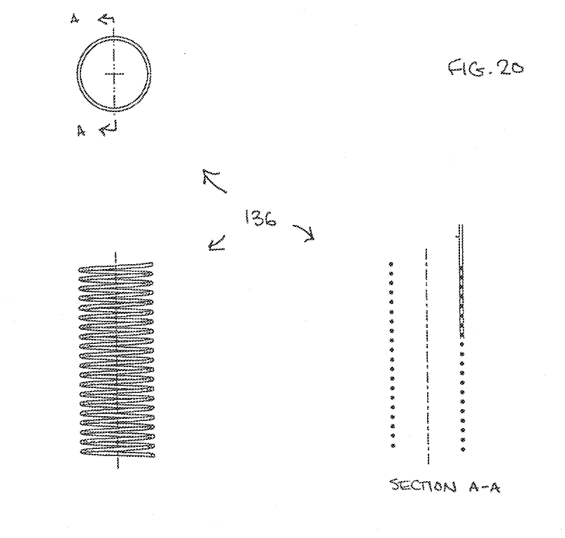

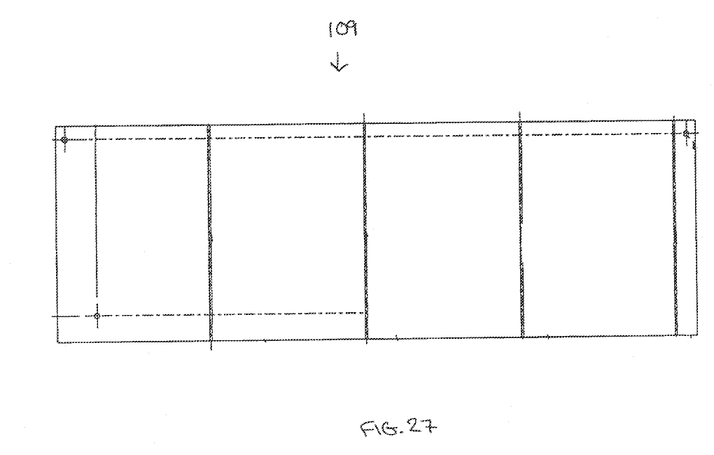

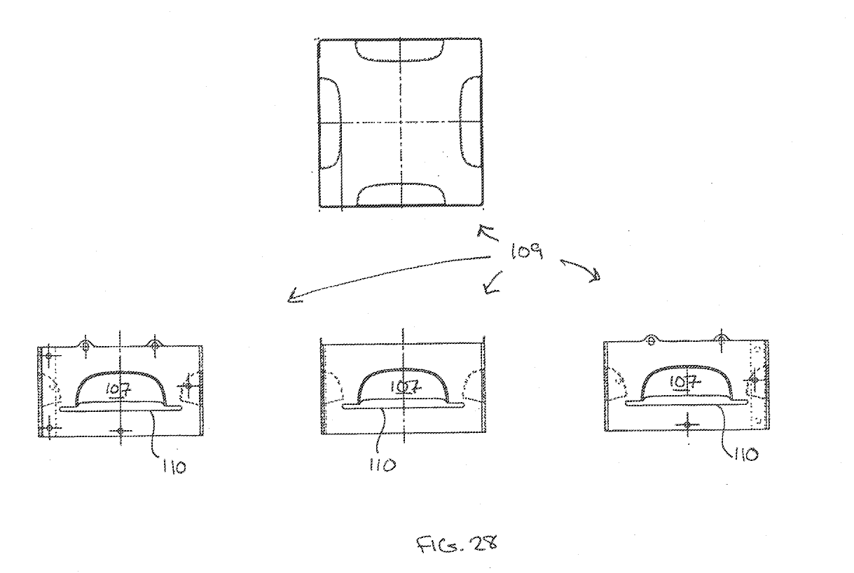

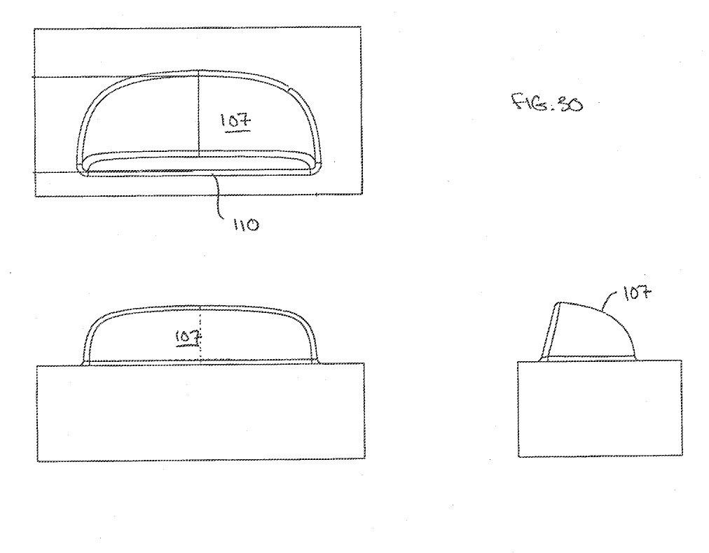

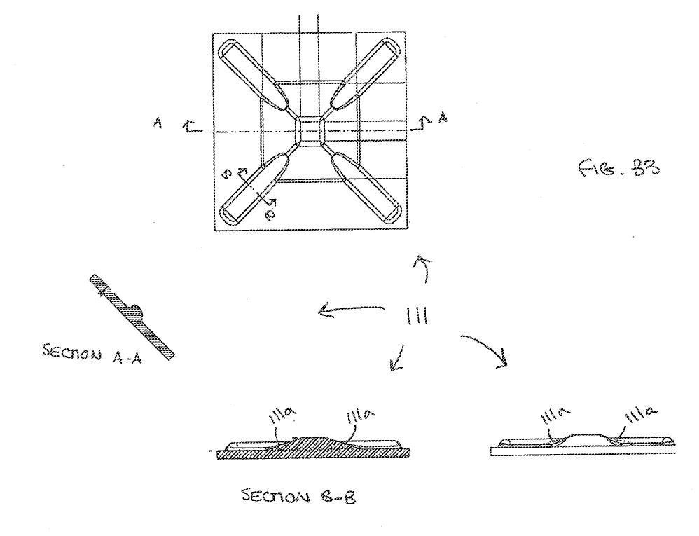

FIGS. 1-33 illustrate an animal feeder 100 according to an embodiment of the invention. The animal feeder 100 can be used to dispense food to an animal such as a bird. The feeder 100 or portions thereof can be made of any material including metal, plastic, wood, or the like, and can be coated or include parts fabricated with a substance which prevents animals from chewing on or otherwise destroying them including pepper or other chemical agents.

The animal feeder 100 includes an outer housing 102, an inner housing 104, a cover 106 and a hanger 108. The hanger 108 is a cable and includes a sleeve 105 positioned above the outer housing 102. The sleeve 105 is approximately cylindrical and is positioned about the hanger 108 such that the hanger 108 and the sleeve 105 are co-axial. The sleeve 105 can be coupled to the cover 106 or the outer housing 102, or can simply be supported by one of the two, and is slidable axially relative to the hanger 108. In some embodiments, the hanger 108 can be a rigid member and the sleeve 105 can be a flexible and/or bendable member. In other embodiments, the hanger 108 can be a flexible member and the sleeve 105 can be a rigid member. In still other embodiments, both the hanger 108 and the sleeve 105 can be rigid members, or alternatively, both the hanger 108 and the sleeve 105 can be flexible members.

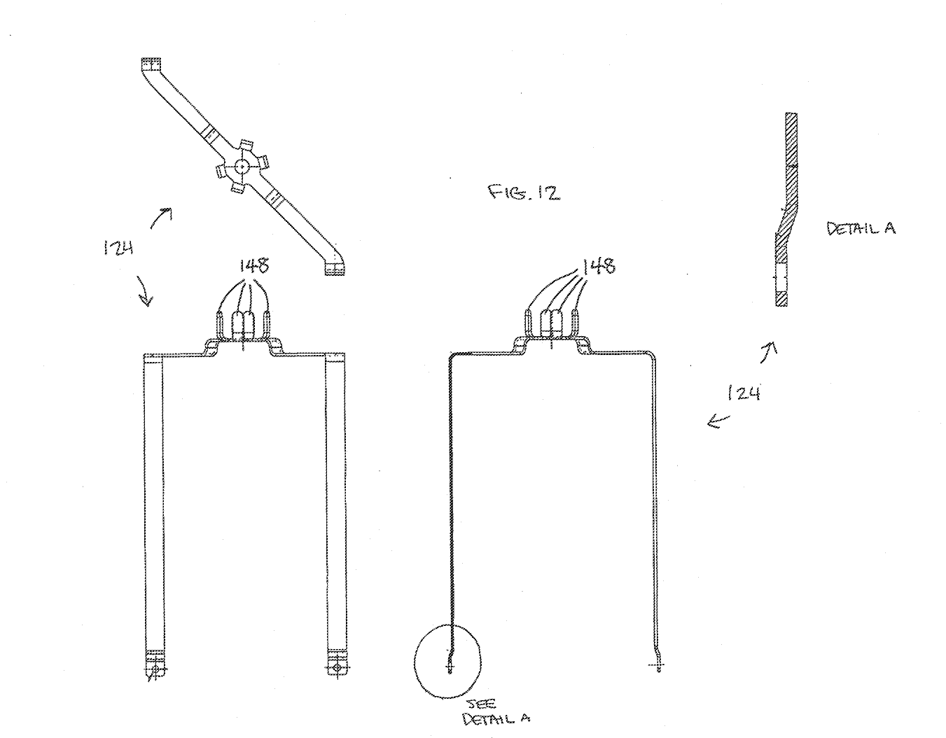

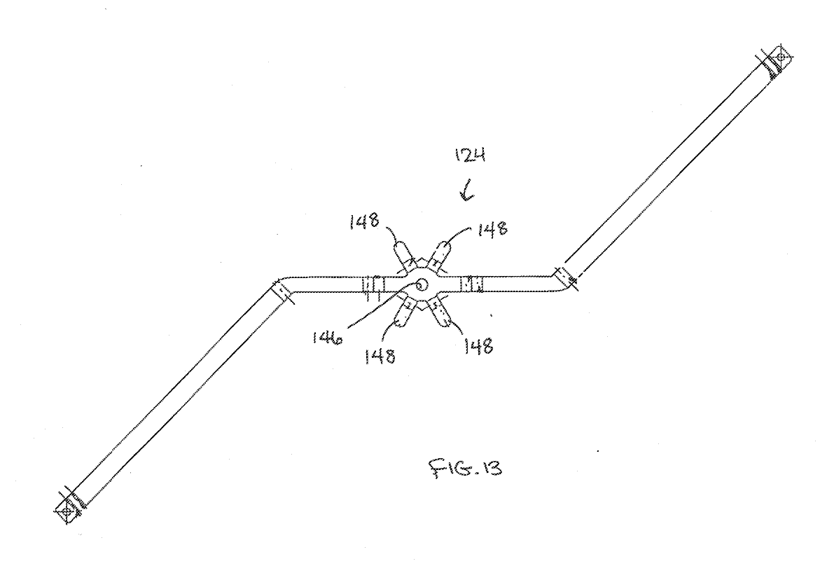

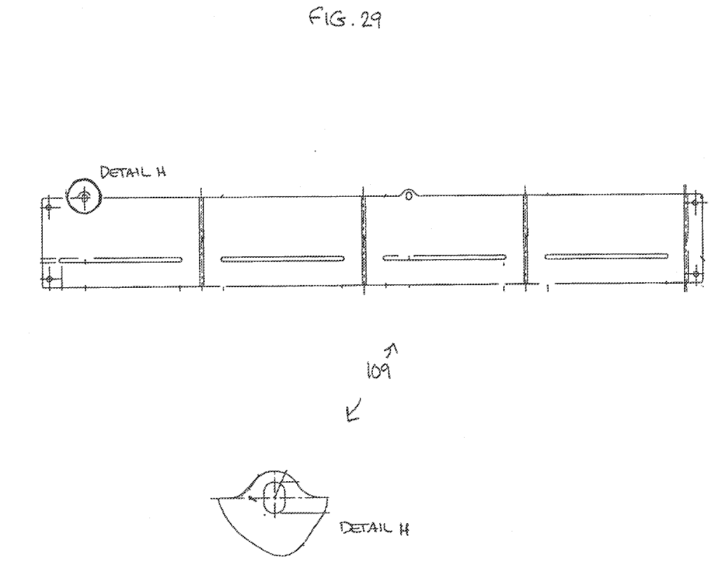

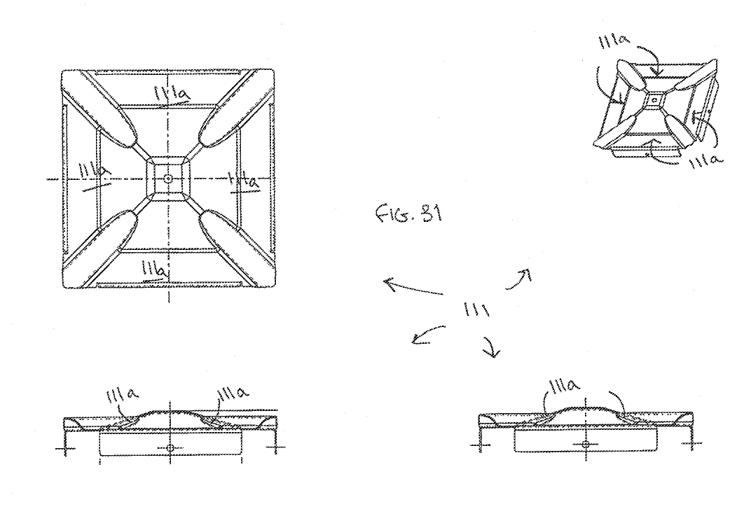

FIGS. 9 and 10 illustrate the inner housing 104. The inner housing 104 includes a bin 109 defining a cavity 109a for storing a quantity of animal feed. The inner housing 104 includes an open top end which allows for refilling and cleaning of the inner housing 104. The bin 109 is at least partially formed of a transparent or mesh-like material so that animal feed within the cavity 109a is visible. As illustrated in FIGS. 28 and 30, the inner housing 104 includes a plurality of ports 110 for accessing animal feed within the cavity 109a. The inner housing 104 also includes an inwardly protruding lip 107 formed in the bin 109, partially covering each of the ports 110. The lips 107 ensure that when the inner housing 104 is filled with feed, the feed will not spill out of the ports 110 due to gravity.

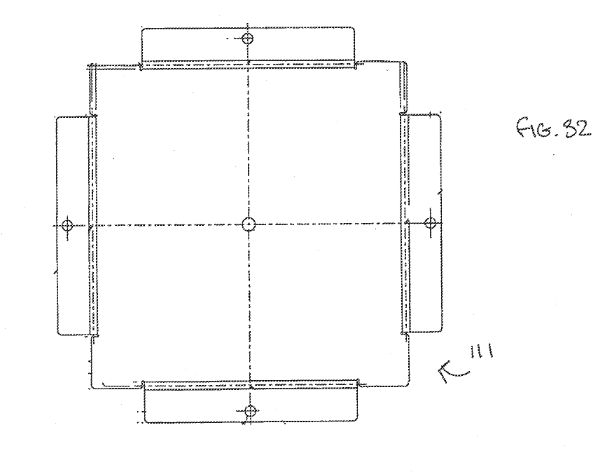

The inner housing 104 includes a diverter 111 located at a lower end of the inner housing 104 that extends upwardly into the cavity 109a. As shown in FIGS. 31-33, the diverter 111 is peaked or approximately pyramid-shaped so as to form a downward sloping surface 111a adjacent each of the ports 110. In other embodiments, the diverter 111 can have other shapes and configurations, such as, for example, rotund, convex, ramp-shaped, and the like. The diverter 111 servers to direct or divert animal feed within the cavity 109a towards each of the ports 110 for access by an animal.

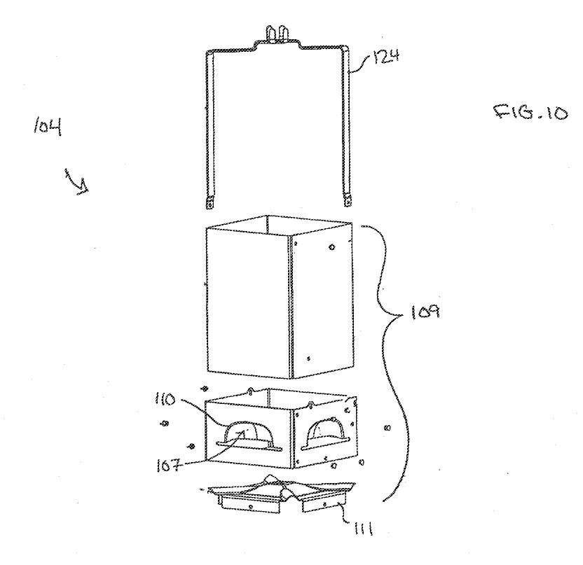

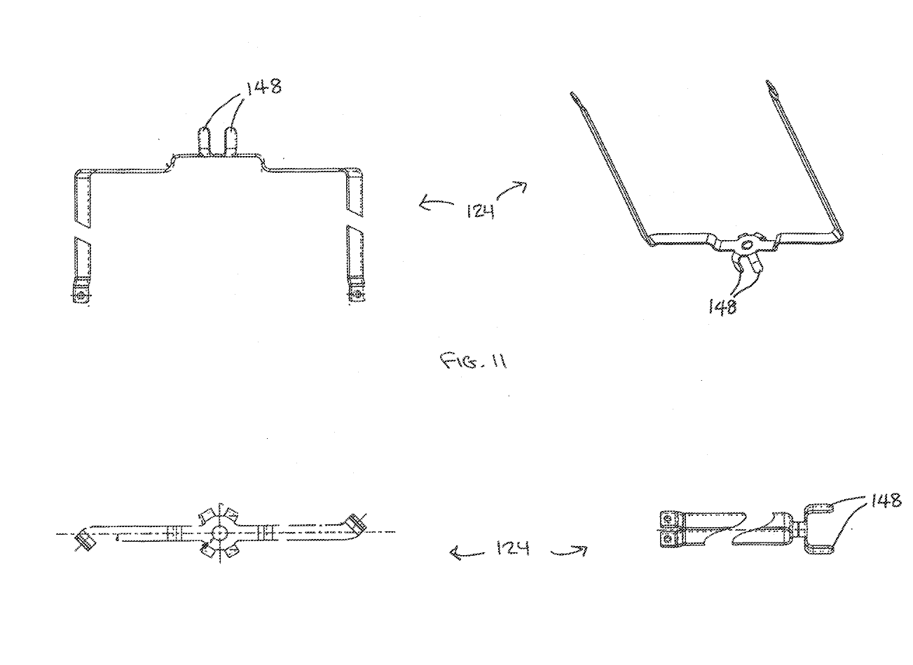

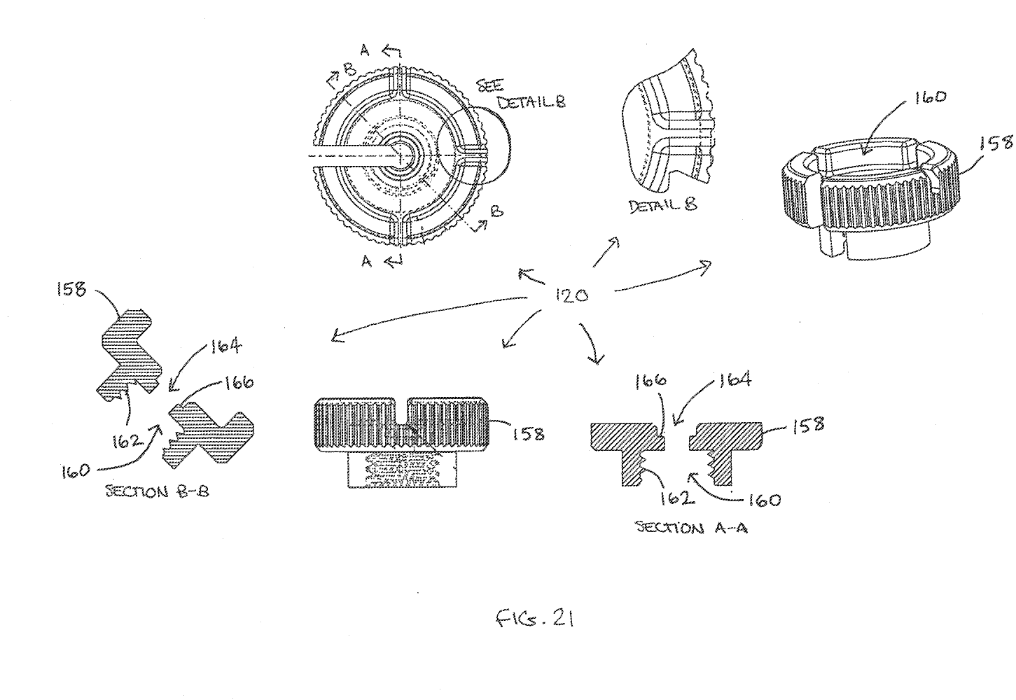

FIGS. 7 and 8 illustrate the outer housing 102. The outer housing 102 is formed from a pair of opposing outer housing members 102a coupled to one another. The outer housing 102 is slightly larger than the inner housing 104 so as to receive the inner housing 104 within a cavity 112. The outer housing 102 of the illustrated embodiment is provided with a decorative pattern on lateral surfaces 103. The decorative pattern forms openings in the walls of the outer housing 102 so that portions of the inner housing 104 are visible. In other embodiments, the decorative pattern is not included. The outer housing 102 also includes a plurality of openings 114. The openings 114 are approximately aligned with respect to the inner housing ports 110 so as to permit selective access to animal feed within the cavity 109a. Animal perches 144 (see FIGS. 8 and 19) are positioned below the openings 114.

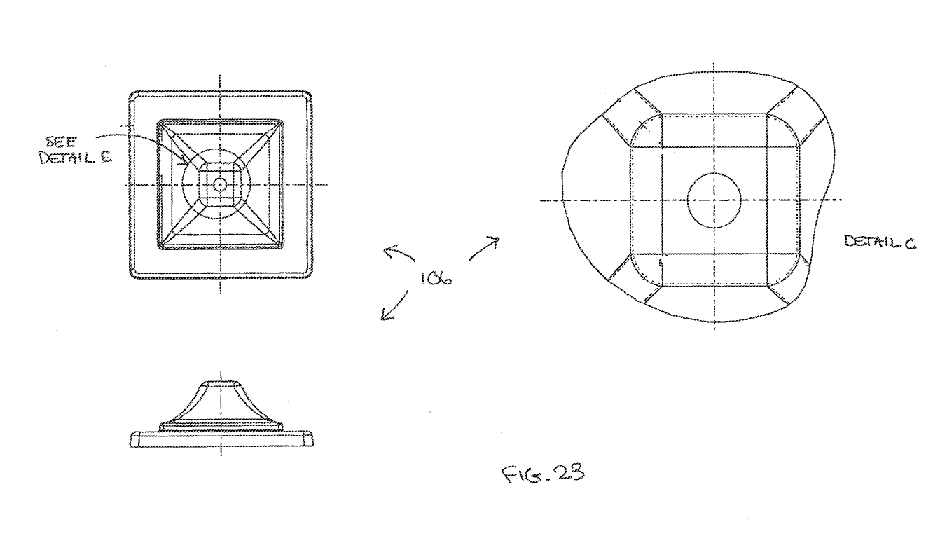

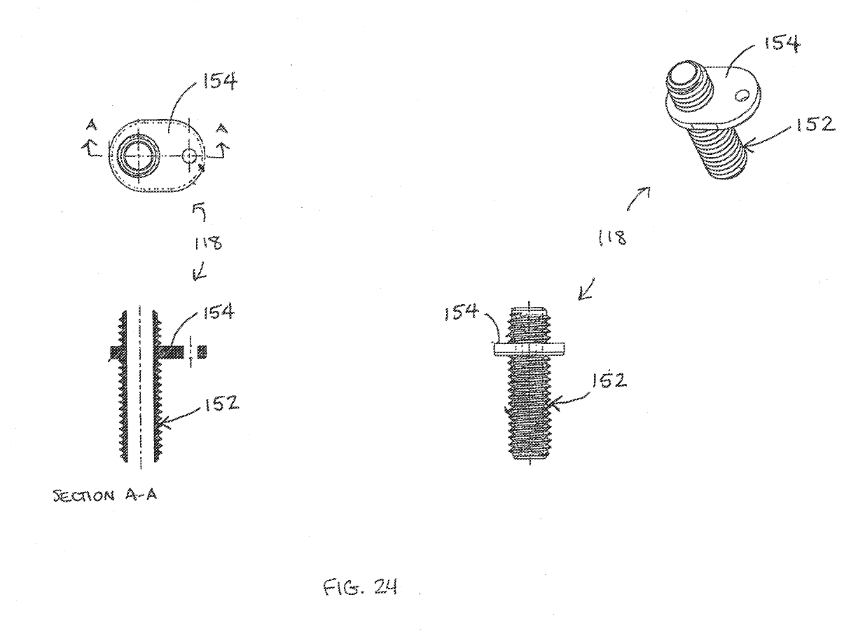

FIG. 23 illustrates the cover 106. The cover 106 of the illustrated embodiment is approximately square shaped and peaked. The cover 106 is supported by open upper ends of the outer housing 102 and a mounting member 118. The cover 106 is secured to the mounting member 118 by a locking member 120. The locking member 120, illustrated in FIG. 21, includes a knob 158 and a bore 160 extending through the center of the locking member 120. The bore 160 has a diameter sized to accommodate the hanger 108 which extends through it when the feeder 100 is assembled and hung, yet allows the hanger to be withdrawn and the sleeve removed so one or both elements can be positioned within the cavity 109a for shipping or storage. A threaded portion 162 of the bore enables the locking member 120 to be positioned in locked and unlocked states. When the locking member 120 is in an unlocked state, the cover 106 is removable for adding animal feed to the inner housing cavity 109a. When the locking member 120 is in a locked state, the cover 106 is secured to the mounting member 118, and inhibits ingress of water and other debris into the cavity 109a. The locking member 120 also includes an annular recess 164 for receiving an end of the sleeve 105 in the knob. The recess 164 surrounds the bore 160 extending through the locking member 120 and is positioned at the opposite end from the threaded portion 162. The ridge 166 formed between the recess 164 and the bore 160 supports and retains the sleeve 105 in a position in which the sleeve 105 extends from the knob 158 of the locking member 120 and along the hanger 108 above the cover 106.

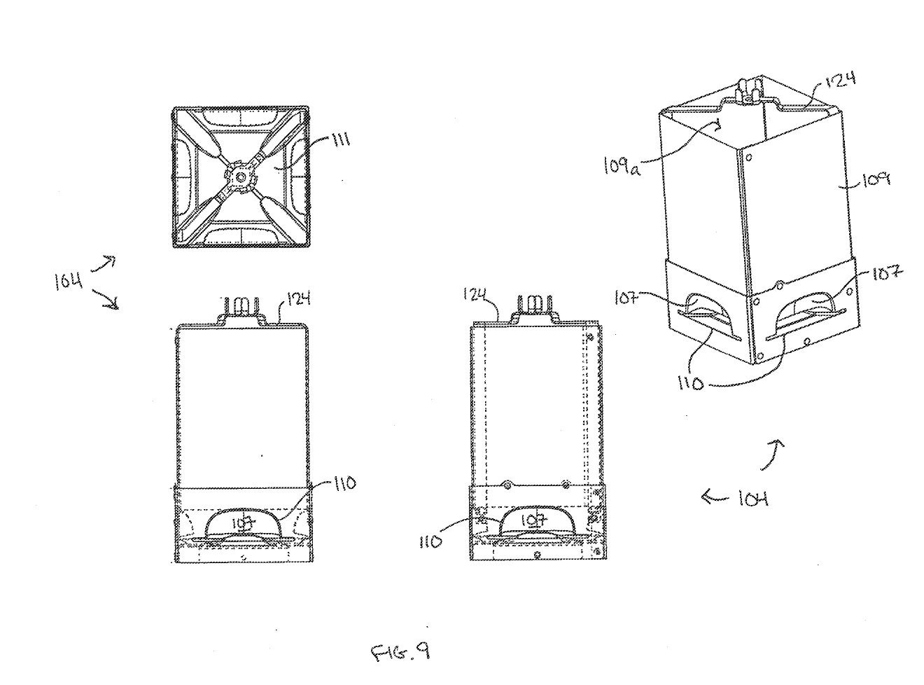

FIGS. 6A and 6B illustrate a guard mechanism 130 for inhibiting access to animal feed within the inner housing 104. The guard mechanism 130 facilitates movement of the outer housing 102 relative to the inner housing 104 from a first or aligned orientation for permitting access to feed within the inner housing 104 to a second or non-aligned orientation for inhibiting access to feed within the inner housing 104. In the aligned orientation, the openings 114 of the outer housing 102 are aligned with the corresponding ports 110 of the inner housing 104 to form a pathway so that feed is accessible. In the non-aligned orientation, the openings 114 of the outer housing 102 are vertically displaced from the ports 110 of the inner housing 104 so that no pathway to the feed is provided.

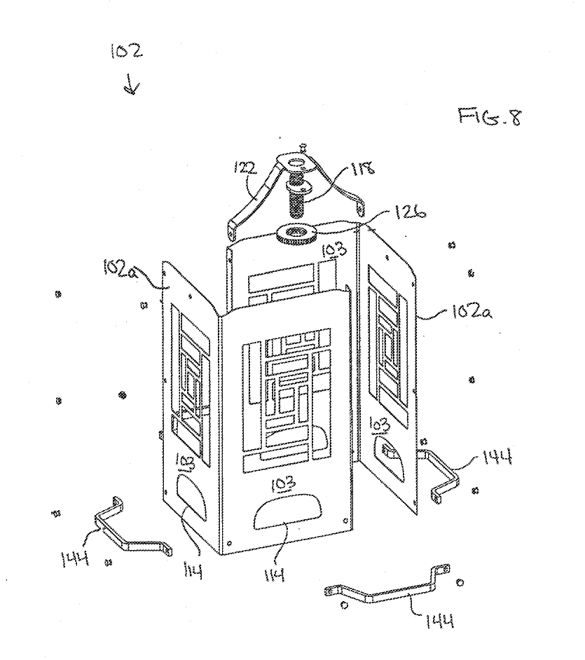

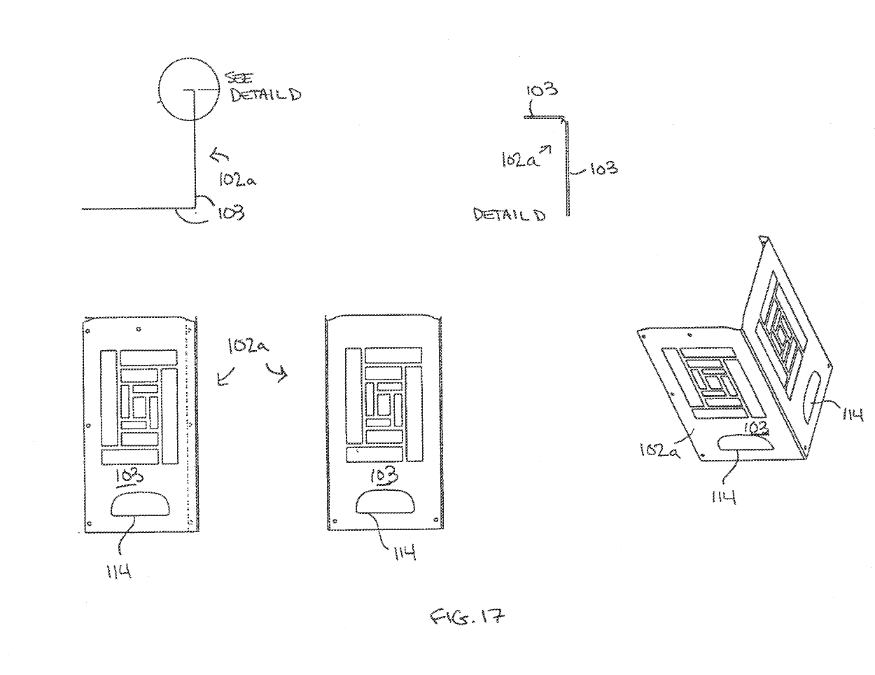

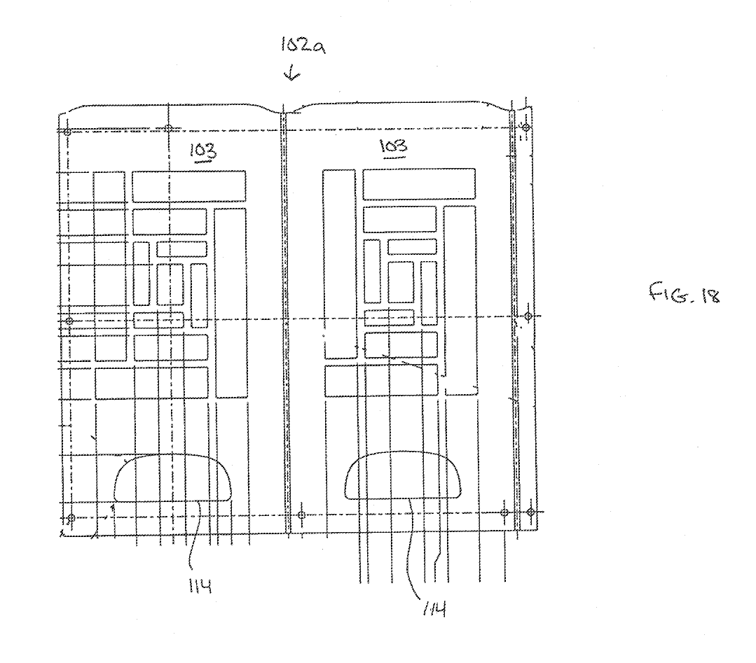

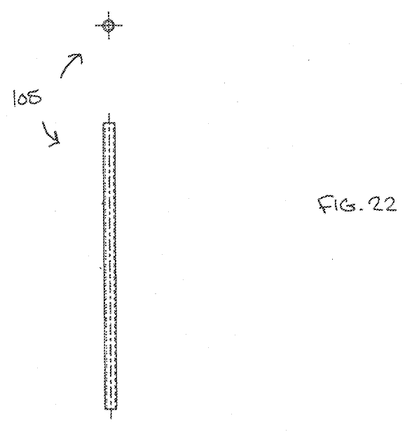

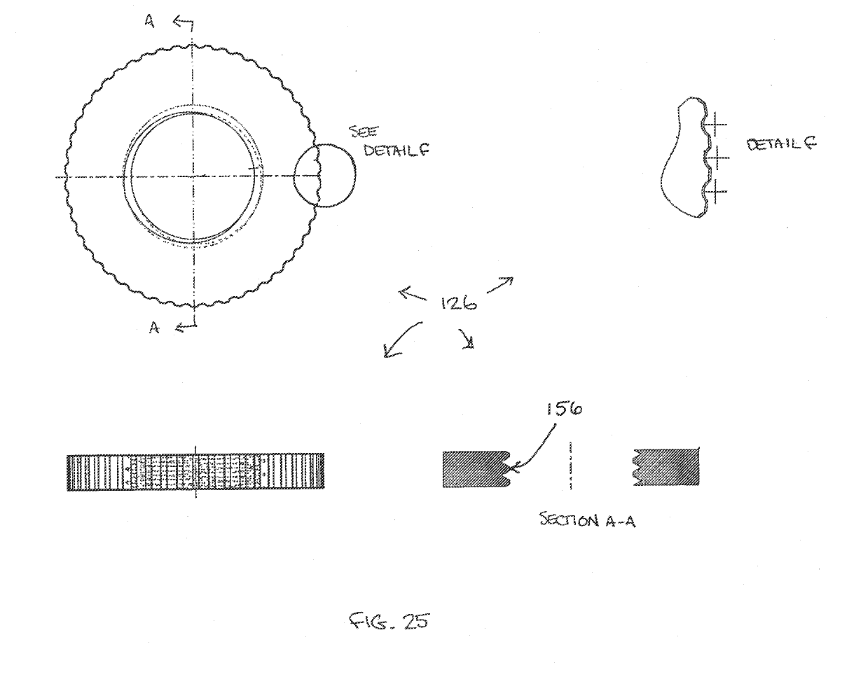

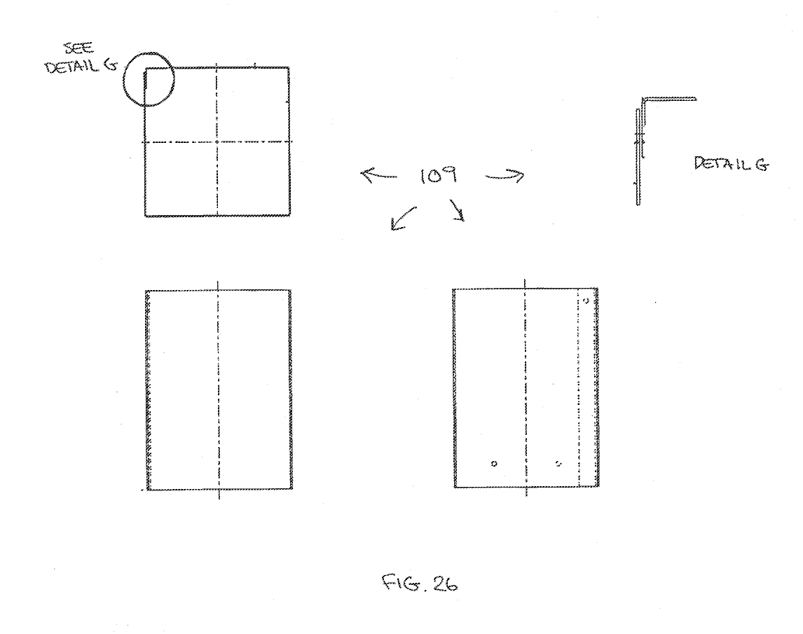

As shown in FIGS. 5-6B, 8, and 10, the guard mechanism 130 includes a lower spring mount 124 (see FIGS. 11-14), a mounting member 118 (see FIG. 24), a spring 136 (see FIG. 20), an upper spring mount 122 (see FIGS. 15 and 16), and an adjuster key 126 (see FIG. 25). The lower spring mount 124 is coupled to an upper end of the inner housing 104 and defines an aperture 146 around which spring retaining portions 148 extend. The upper spring mount 122 is coupled to an upper end of the outer housing 102 and extends upward into the space defined by the cover 106. The upper spring mount 122 defines an aperture 150 sized to accommodate the mounting member 118 which defines an outer threaded surface 152. The mounting member 118 includes an integral wing stop 154 between its ends which enables the mounting member 118 to be positioned with respect to the upper spring mount 122, as is best shown in FIG. 8. The adjuster key 126 includes a threaded inner surface 156 enabling the adjuster key 126 to be positioned and retained along the length of the mounting member 118 below the wing stop by way of threaded engagement between the threaded inner surface 156 of the adjuster key 126 and the threaded outer surface 152 of the mounting member 118.

When the feeder 100 is assembled, the spring 136 is positioned and compressed between the lower spring mount 124 and the wing adjuster key 126. Consequently, the spring 136 biases the outer housing 102 axially upward (along the hanger 108) with respect to the inner housing 104 such that the openings 114 in the outer housing are aligned with the ports 110 in the inner housing 104 allowing access from outside the feeder 100 to the feed within the inner cavity 109a. If a net force applied to the outer housing 102 opposing the axial bias of the spring 136 is greater than the force of the spring 136, the outer housing 102 will move axially downward with respect to the inner housing 104 and the openings 114 will no longer be in alignment with the ports 110, preventing access to the cavity 109a from outside the feeder 100.

The guard mechanism 130 is adjustable so as to increase or decrease the length of the spring and, therefore, increase or decrease the force exerted by the spring 136 (i.e., spring force), and thus increase or decrease the weight on the animal perches 144 and/or the sleeve 105 necessary to displace the outer housing 102 so as to open the apertures 110. Specifically, the adjuster key 126 is coupled to the mounting member 118 for adjusting the compression or pre-load in the spring 136 by infinite amounts. The greater the distance between the wing stop 154 and the adjuster key 126, the more the spring will be compressed, and the greater the force that will be required to mis-align the openings 114 and the ports 110.

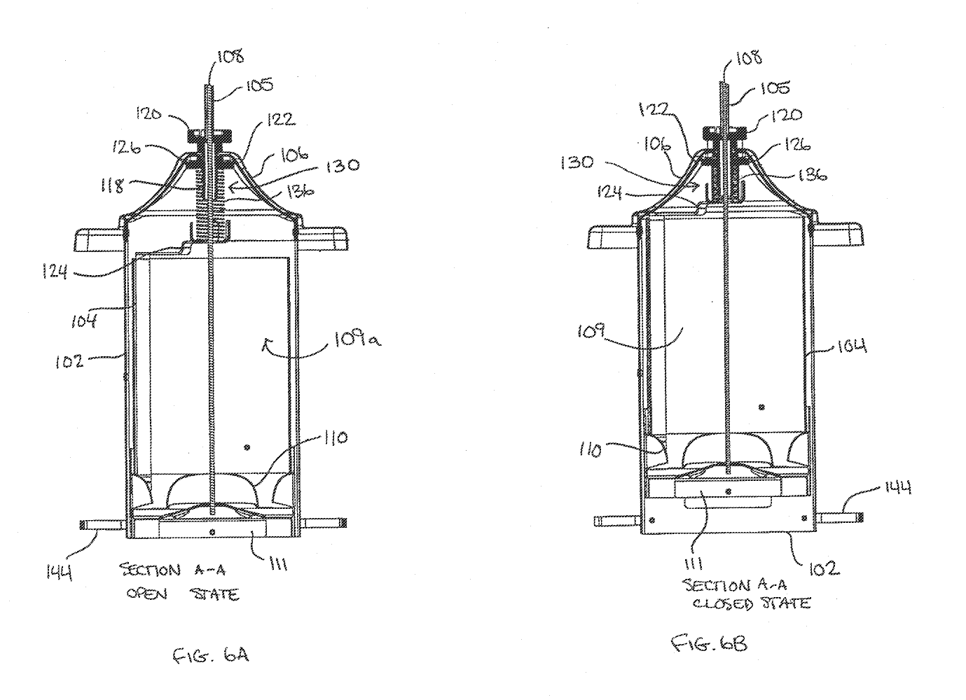

With reference to FIG. 3, the hanger 108 has a first end 140 and a second end 142. The second end 142 of the hanger 108 can be coupled to a support structure such as a hook or tree-branch to suspend the animal feeder 100 mid-air. As illustrated in FIGS. 5-6B, locking member 120, cover 106, upper spring mount 122, mounting member 118, lower spring mount 124, and diverter 111 define aligned bores/holes through which the hanger 108 extends. The first end 140 of the hanger 108 is secured below the diverter 111 to prevent movement of the inner housing 104 with respect to the hanger 108. Thus, the outer housing 102 floats relative to the inner housing 104. The outer housing 102 is located at a neutral position relative to the inner housing 104 in which the weight of the outer housing and the guard mechanism 130 are balanced by the spring force of the spring 136.

The diverter 111 diverts a portion of the animal feed within the cavity 109a towards each of the aligned aperture pairs 110, 114. Animals such as birds can grasp the animal perches 144 and can access animal feed at the aligned apertures 110, 114. Each animal supported on the animal perches 144 contributes to a downwardly directed force on the outer housing 102. When the weight on the animal perches 144 exceeds the spring force of the spring 136, the spring 136 compresses vertically, such that the outer housing 102 moves downwardly along a vertical axis relative to the inner housing 104. This causes the apertures 114 of the outer housing 102 to become mis-aligned with the apertures 110 of the inner housing 104. The outer housing 102 blocks the aperture 110, so that the pathway through the inner housing 104 and the outer housing 102 to the animal feed within the cavity 109a, is blocked, thus inhibiting access to the animal feed at all of the apertures 110.

Access to feed is also inhibited when animals grasp and/or alight on the hanger 108 above the cover 106. Specifically, when an animal such as a squirrel grasps the sleeve 105, the weight of the animal causes the sleeve 105 to slide downwardly relative to the hanger 108. This causes the cover 106 and the outer housing 102 to slide downwardly against the force of the spring 136. The outer housing openings 114 are thus mis-aligned relative to the inner housing ports 110 such that access to feed is blocked.

Rotation of the adjuster key 126 in a first direction, such as clockwise, causes it to travel in a first direction, such as downward, over the mounting member 118. As the adjuster key 126 travels downwardly, the spring 136 is compressed or pre-loaded between the adjuster key 126 and the lower spring mount 124. Conversely, rotation of the adjuster key 126 in a second direction opposite the first direction, such as counterclockwise, causes it to travel in a second direction opposite the first direction, such as upward, over the mounting member 118. As the adjuster key 126 travels upwardly, the spring 136 is released such that compression on the spring 136 is reduced.

The adjuster key 126 is operable to adjust the sensitivity of the guard mechanism 130 for blocking access to animal feed within the cavity 109a. An increase in the spring force increases the force on the outer housing 102 necessary to move the outer housing 102 into the non-aligned orientation blocking the ports 110 to the animal feed in the cavity 109a. Likewise, a reduction in the spring force reduces the force on the outer housing 102 necessary to move the outer housing 102 into the non-aligned orientation. Thus, the adjuster key 126 can be used to increase or decrease the spring force of the spring 136, thereby increasing or decreasing the minimum additional weight on the outer housing 102 that will move the outer housing 102 into the non-aligned orientation.

The adjuster key 126 can be used to increase the spring force so as to permit small and medium sized birds to perch on the animal perches 144 and access feed while inhibiting larger, heavier birds such as crows and rodents such as squirrels from accessing feed. The adjuster key 126 can be used to decrease the spring force so as to permit small birds such as hummingbirds to access feed while inhibiting medium-sized birds such as sparrows from feeding, as well as larger birds and rodents.

It should be appreciated that the invention is not limited to the embodiment shown in FIGS. 1-33. For example, the feeder can have a wide variety of shapes and configurations adapted to feed different types of birds and other animals in different habitats and in different weather conditions. Thus, the invention provides, among other things, a feeder for dispensing feed to a bird with an adjustable guard mechanism for limiting access to the feed.

What is claimed is:

1. An animal feeder mountable to an exterior support, the animal feeder comprising:
an inner housing having a cavity for containing feed;
an outer housing for selectively blocking and providing access to the cavity, wherein access is dependent upon a force exerted on the outer housing; and
an adjustment mechanism for adjusting the force required to block access.

2. The animal feeder of claim 1, wherein the adjustment mechanism is infinitely adjustable between a minimum and a maximum.

3. The animal feeder of claim 1, wherein the outer housing is movable with respect to the inner housing between a first position and a second position, wherein access to the feed is provided in the first position and wherein access to the feed is blocked in the second position.

4. The animal feeder of claim 1, wherein the adjustment mechanism is disposed between the inner housing and the outer housing.

5. An animal feeder mountable on an exterior support, the animal feeder comprising:
an inner housing defining a cavity for containing feed and including at least one port for providing access to the cavity;
an outer housing having at least one opening and being supported on the inner housing for movement relative to the housing between an opened position, in which the at least one opening and the at least one port are substantially aligned, and a closed position, in which the at least one opening and the at least one port are substantially misaligned, wherein the outer housing is in the opened position in response to a first force on the outer housing and wherein the outer housing is in the closed position in response to a second force on the outer housing, wherein the second force is greater than the first force;
a guard mechanism coupled between the inner housing and the outer housing for facilitating movement between the opened position and the closed position, the guard mechanism including an adjustment mechanism for adjusting the sensitivity of the guard mechanism such that the value of the second force required to place the outer housing in the closed position is adjustable.

6. The animal feeder of claim 5, wherein the adjustment mechanism is infinitely adjustable between a minimum and a maximum.

7. The animal feeder of claim 5, wherein the guard mechanism includes a spring capable of being pre-loaded, wherein the adjustment mechanism changes the pre-load of the spring.

8. The animal feeder of claim 7, further comprising a lower spring mount coupled to the inner housing and upper spring mount coupled to the outer housing, wherein the spring is disposed between the lower spring mount and the upper spring mount.

9. The animal feeder of claim 8, further comprising a mounting member coupled to the outer housing, wherein the mounting member includes a threaded outer surface and a stop positioned between a first end of the mounting member and a second end of the mounting member, wherein the stop is positioned adjacent the upper spring mount, wherein the adjustment mechanism includes an inner threaded surface for mating with the outer threaded surface of the mounting member, wherein the adjustment mechanism is axially adjustable with respect to the mounting member by way of threaded engagement therebetween, and wherein the spring is disposed between the adjustment mechanism and the lower spring mount.

10. The animal feeder of claim 9, further comprising a hanger for mounting the animal feeder to the exterior support, wherein the hanger is coupled to the inner housing such that the hanger is fixed relative to the inner housing and such that the outer housing is movable relative to the hanger, wherein the hanger passes through a central aperture in the mounting member.

11. The animal feeder of claim 10, further comprising a sleeve coaxially surrounding a portion of the hanger, wherein the sleeve is slidable relative to the hanger, and wherein the sleeve is operable to move the outer housing between the first position and the second position.

12. The animal feeder of claim 9, further comprising a locking member including a bore having a threaded inner surface configured to threadedly engage the threaded outer surface of the mounting member for selectively locking the upper spring mount between the locking member and the stop of the mounting member.

13. The animal feeder of claim 12, further comprising a cover coupled to the outer housing for covering the cavity of the inner housing, wherein the cover is selectively secured between the locking member and the stop of the mounting member.

14. The animal feeder of claim 5, further comprising a locking mechanism moveable relative to the outer housing between a locked position, in which the locking mechanism secures a cover to the outer housing, and an unlocked position, in which the cover is moveable to provide access to the inner housing.

15. An animal feeder mountable on an exterior support, the animal feeder comprising:
an inner housing defining a cavity for containing feed and including at least one port for providing access to the cavity;
an outer housing having at least one opening and being supported on the inner housing for movement relative to the housing between an opened position, in which the at least one opening and the at least one port are substantially aligned, and a closed position, in which the at least one opening and the at least one port are substantially misaligned;
a spring coupled between the inner housing and the outer housing for applying a spring force between the inner housing and the outer housing; and
an adjustment mechanism for adjusting the spring force.

16. The animal feeder of claim 15, wherein the adjustment mechanism is infinitely adjustable between a minimum and a maximum.

17. The animal feeder of claim 15, further comprising a mounting member having a threaded outer surface, wherein the adjustment mechanism includes a threaded inner surface configured to threadedly engage the threaded outer surface of the mounting member such that the adjustment mechanism is moveable axially with respect to the mounting member, wherein axial movement of the adjustment mechanism acts to load and unload the spring for adjusting the spring force of the spring.

18. The animal feeder of claim 17, wherein the spring is positioned substantially coaxially with respect to the mounting member.

19. The animal feeder of claim 15, wherein the outer housing is in the opened position in response to a first force on the outer housing acting against the spring force, and wherein the outer housing is in the closed position in response to a second force on the outer housing acting against the spring force, wherein the second force is greater than the first force.
